(19) United States
(12) Patent Application Publication
(10) Pub. No.: US 2012/0046769 A1
(43) Pub. Date: Feb. 23, 2012

(54) ELECTRONIC EQUIPMENT, RESERVATION METHOD, AND PLAYBACK DATA SEARCH METHOD

(75) Inventor: Hiroshi EJIRI, Osaka (JP)

(73) Assignee: SANYO ELECTRIC CO., LTD., Osaka (JP)

(21) Appl. No.: 13/156,798

(22) Filed: Jun. 9, 2011

(30) Foreign Application Priority Data
Aug. 18, 2010 (JP) 2010-183495

(51) Int. Cl. G06F 17/00

(52) U.S. Cl. 700/94

(57) ABSTRACT

An electronic equipment includes a sound recording portion to store sound inputted from outside, a reserved sound recording control portion to cause the sound recording portion to perform a sound recording based on reservation data including at least a start date and time and a finish date and time, a time axis display portion to display a time axis for one day of a day to be processed, an extracting portion to extract reservation data whose start date and time or finish date and time is included in the day to be processed, a reservation figure display portion to display for each of the reservation data extracted a reservation figure indicating an already scheduled reservation between a starting position on the time axis corresponding to the start date and time and a finish position on the time axis corresponding to the finish date and time of the reservation data, a designating portion to designate any given position on the time axis displayed, and a reservation data generating portion to generate reservation data in which time determined based on the position designated on the time axis is set as a start time or a finish time.

This application is based on Japanese Patent Application No. 2010-183495 filed with Japan Patent Office on Aug. 18, 2010, the entire content of which is hereby incorporated by reference.

### BACKGROUND OF THE INVENTION

1. Field of the Invention

The present invention relates to an electronic equipment, a reservation method, and a playback data search method, and more specifically to an electronic equipment in which a start time and a finish time are designated to schedule or reserve a sound recording, and a reservation method and a playback data search method to be executed by that electronic equipment.

2. Description of the Related Art

A compact electronic equipment such as an IC recorder has a smaller area of display on the display screen in comparison to a television apparatus and the like. In a conventional IC recorder, when playing back already recorded data, an overview list of file names is displayed, and a user would designate one of the file names being displayed in the list so as to playback the data of the designated file. However, although some of the file names included information such as the date and the time of the sound recording, it required practice to determine from the file name which program it was that the sound recorded data was made from.

A record-playback device is known in which program names of data streams (programs) stored in the record-playback device are displayed in a record list in a calendar format, and in which a user operates a cursor, and when one date is selected, program information of the programs recorded on the selected date is displayed as a program-by-program record list on the same screen.

The screen of a conventional record-playback device, however, is a screen to be displayed on a television apparatus so that there is the problem that it cannot be applied to an IC recorder which can only be equipped with a compact display device with a relatively small display resolution.

In addition, when a sound recording of a radio program and the like is to be scheduled or reserved, the date, the start time, the finish time, the channel name and the like of the sound recording must be designated. With a conventional IC recorder, if the time frame for which the recording was to be scheduled overlapped in time with an already reserved program, a notification of an error was made to the user after necessary information had been inputted in numbers and such for the reservation. Thus, there was the problem that the user could not know the overlapping of the sound recording time until after the necessary information for the reservation of the sound recording had been inputted in numbers, which complicated the operation.

### SUMMARY OF THE INVENTION

According to one aspect of the present invention, an electronic equipment includes a sound recording portion to store sound inputted from outside, a control portion to cause the sound recording portion to perform a sound recording based on reservation data including at least a start date and time and a finish date and time, a time display portion to display a time axis for one day of a day, an extracting portion to extract reservation data whose start date and time or finish date and time is included in the day, a reservation figure display portion to display for each of the reservation data extracted a figure indicating an already scheduled reservation between a starting position on the time axis corresponding to the start date and time and a finish position on the time axis corresponding to the finish date and time of the reservation data, a designating portion to designate any given position on the time axis displayed, and a generating portion to generate reservation data in which time determined based on the position designated on the time axis is set as a start time or a finish time.

According to another aspect of the present invention, an electronic equipment includes a sound recording portion to store sound inputted from outside and a control portion to cause the sound recording portion to perform a sound recording based on reservation data including at least a start date and time, a finish date and time, and a designating method for specifying a date to make the sound recording, wherein the designating method included in the reservation data is one selected from three designating methods which are a designating method to specify a date, a designating method to specify a day of the week, and a designating method to specify everyday, and the electronic equipment further includes a time display portion to display a time axis for one day of a day, an extracting portion to extract reservation data whose start date and time or finish date and time is included in the day, a reservation display portion to display for each of the reservation data extracted a reservation figure indicating an already scheduled reservation between a starting position on the time axis corresponding to the start date and time and a finish position on the time axis corresponding to the finish date and time of the reservation data, and a placing portion to place a symbol corresponding to a classification of the reservation data in a vicinity of the reservation figure.

According to a further aspect of the present invention, an electronic equipment includes a playback portion to playback sound stored along with sound recording information including at least a start date and time and a finish date and time of a sound recording made, a time display portion to display a time axis for one day of a day, an extracting portion to extract sound recording information whose start date and time or finish date and time is included in the day, a recording display portion to display for each of the sound recording information extracted a sound recording figure indicating a completed sound recording between a starting position on the time axis corresponding to the start date and time and a finish position on the time axis corresponding to the finish date and time of the sound recording information, and a designating portion to designate any given position on the time axis displayed, wherein the playback portion plays back the sound stored along with the sound recording information corresponding to the sound recording figure when the sound recording figure is displayed at the position designated on the time axis.

According to a still further aspect of the present invention, a reservation method causes an electronic equipment to execute the steps of recording sound inputted from outside based on reservation data including at least a start date and time and a finish date and time, displaying a time axis for one day of a day, extracting reservation data whose start date and time or finish date and time is included in the day, displaying for each of the reservation data extracted a figure indicating an already scheduled reservation between a starting position on the time axis corresponding to the start date and time and a finish position on the time axis corresponding to the finish date and time of the reservation data, designating any given position on the time axis displayed, and generating reservation data in which time determined based on the position designated on the time axis is set as a start time or a finish time.

According to a still another aspect of the present invention, a reservation method causes an electronic equipment to execute the step of recording sound inputted from outside based on reservation data including at least a start date and time, a finish date and time, and a designating method for specifying a date to make the sound recording, wherein the designating method included in the reservation data is one selected from three designating methods which are a designating method to specify a date, a designating method to specify a day of the week, and a designating method to specify everyday, and the reservation method further causes the electronic equipment to execute the steps of displaying a time axis for one day of a day, extracting reservation data whose start date and time or finish date and time is included in the day, displaying for each of the reservation data extracted a figure indicating an already scheduled reservation between a starting position on the time axis corresponding to the start date and time and a finish position on the time axis corresponding to the finish date and time of the reservation data, and placing a symbol corresponding to a classification of the reservation data in a vicinity of the figure.

According to a still further aspect of the present invention, a playback data search method causes an electronic equipment to execute the steps of playing back sound stored along with sound recording information including at least a start date and time and a finish date and time of a sound recording made, displaying a time axis for one day of a day, extracting sound recording information whose start date and time or finish date and time is included in the day, displaying for each of the sound recording information extracted a figure indicating a completed sound recording between a starting position on the time axis corresponding to the start date and time and a finish position on the time axis corresponding to the finish date and time of the sound recording information, and designating any given position on the time axis displayed, wherein the step of playing back includes the step of playing back the sound stored along with the sound recording information corresponding to the figure when the figure is displayed at the position designated on the time axis.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of an IC recorder.

FIG. 2 is a schematic functional block diagram showing a hardware arrangement of the IC recorder.

FIG. 3 is a diagram illustrating one example of a data format of reservation data.

FIG. 4 is a block diagram showing an overview of a reservation setting function of a CPU (Central Processing Unit) along with data stored in an EEPROM (Electrically Erasable and Programmable Read Only Memory).

FIG. 5 is a diagram illustrating one example of a reserved day information setting screen.

FIG. 6 is a diagram illustrating one example of a time frame screen.

FIG. 7 is a flow chart showing one example of the flow of a reservation setting process.

FIG. 8 is a flow chart showing one example of the flow of a time frame screen display process.

FIG. 9 is a flow chart showing one example of the flow of a time frame display process.

FIG. 10 is a flow chart showing one example of the flow of a start and finish time setting process.

FIG. 11 is a flow chart showing one example of the flow of a fine-adjustment process.

FIG. 12 is a diagram illustrating one example of a data format of sound recording data.

FIG. 13 is a block diagram showing one example of an overview of a playback setting function of the CPU.

FIG. 14 is a diagram illustrating one example of a sound recording confirmation screen.

FIG. 15 is a flow chart showing one example of the flow of a date search process.

FIG. 16 is a flow chart showing one example of the flow of a date search screen display process.

FIG. 17 is a flow chart showing one example of the flow of a sound recording data decision process.

### DESCRIPTION OF THE PREFERRED EMBODIMENTS

The preferred embodiments of the present invention will be described below in conjunction with the drawings. In the following description, the same or corresponding parts are denoted by the same reference characters. Their names and function are also the same. Thus, a detailed description thereof will not be repeated.

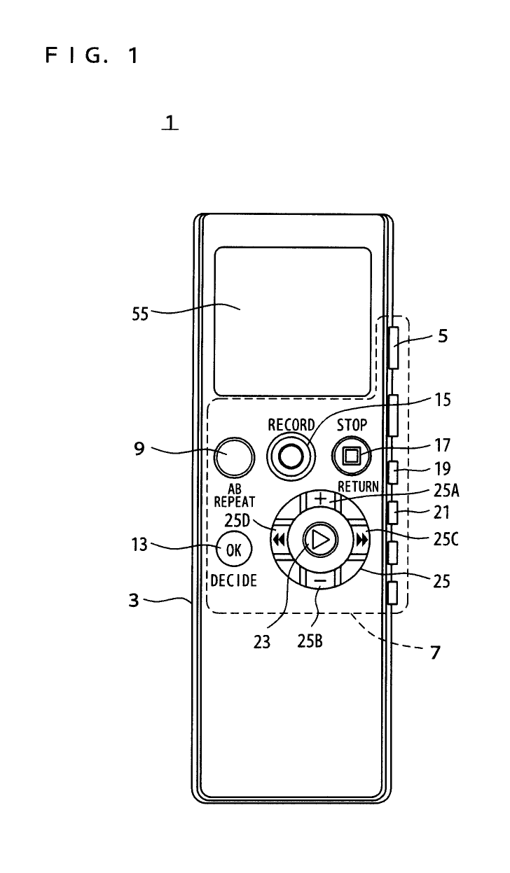

FIG. 1 is a plan view of an IC recorder. An IC recorder 1 includes a body portion 3, a liquid crystal display (LCD) 55 disposed on a front surface of body portion 3, and an operation portion 7 that includes a plurality of buttons arranged on the front surface and a side face of body portion 3. A user is able to operate operation portion 7 while viewing a screen displayed on LCD 55. Moreover, in place of LCD 55, a display such as an organic ELD (Electro Luminescence Display) may be used.

Operation portion 7 includes a changeover switch 5, a repeat button 9, a decide button 13, a sound record button 15, a stop button 17, a reservation button 19, a search button 21, a playback button 23, and a control button 25. Repeat button 9, decide button 13, sound record button 15, stop button 17, playback button 23, and control button 25 are arranged on the front surface of body portion 3, while changeover switch 5, reservation button 19, and search button 21 are arranged on a side face of body portion 3. Control button 25 includes an up button 25A, a down button 25B, a right button 25C, and a left button 25D. For instance, the user can move a cursor displayed on LCD 55 to one of the directions of up, down, left, and right by operating one of up button 25A, down button 25B, left button 25D, and right button 25C. More specifically, if the user presses up button 25A, the cursor moves upward; if the user presses down button 25B, the cursor moves downward; if the user presses left button 25D, the cursor moves leftward; and if the user presses right button 25C, the cursor moves rightward.

Repeat button 9, decide button 13, sound record button 15, stop button 17, playback button 23, control button 25, reservation button 19, and search button 21 are hard keys which are normally OFF but are turned ON when pressed by the user. Changeover switch 5 is a slide switch and switches the state to either one of a first state and a second state. Here, changeover switch 5 is used by the user to set the parameter to determine the source of sound input. More specifically, it is possible to input sound into IC recorder 1 from either of a microphone 33 and a line input terminal 49 to which an external microphone or the like is connected, and while changeover switch 5 is switched to the first state by the user, “microphone input,” which is the parameter for selecting the sound inputted from microphone 33, is set as the parameter to define the source of input, whereas while changeover switch 5 is switched to the second state by the user, “line input,” which is the parameter for selecting the sound inputted from line input terminal 49, is set as the parameter to define the source of input.

Search button 21 is a button for accepting an instruction to display a search screen. The search screen is a screen for selecting a search method and includes an item for designating a date search as the search method and an item for designating a folder search as the search method. The search method is selected as a result of the user operating control button 25, selecting either one of the item for designating the date search and the item for designating the folder search, and pressing decide button 13. The screen for the folder search is a screen which displays by folder a plurality of file names sorted into one or more folders. More specifically, the folder names of one or more folders are displayed in an overview list, and when the user designates a folder name, the names of the files sorted into the designated folder are displayed. The date search will be described later.

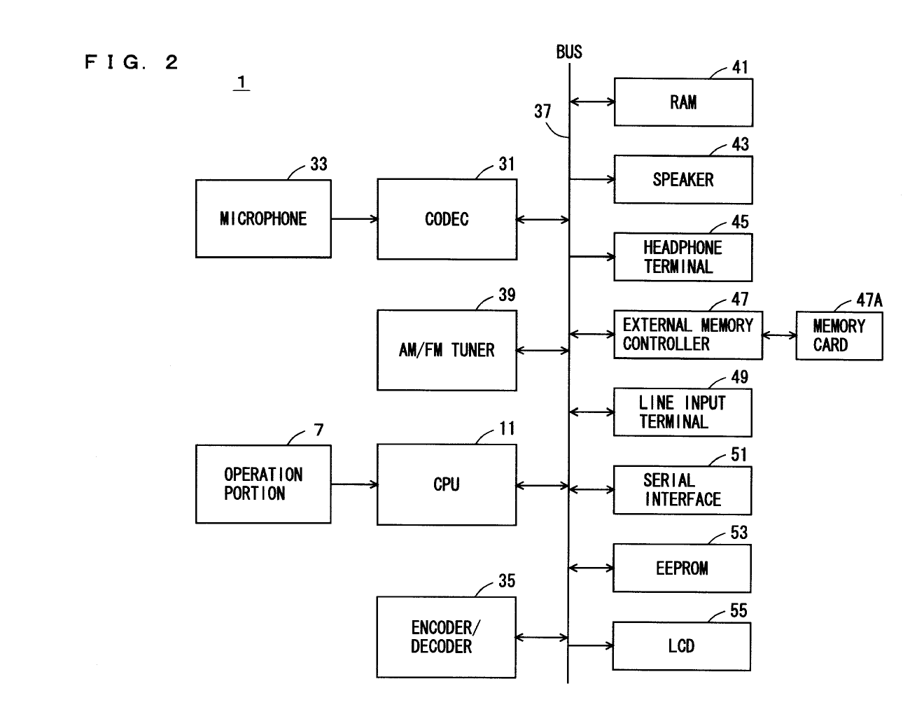

FIG. 2 is a schematic functional block diagram showing a hardware arrangement of the IC recorder. IC recorder 1 includes a central processing unit (CPU) 11 to control the entire IC recorder, and a codec 31, an encoder/decoder 35, an AM/FM tuner 39, a RAM (Random Access Memory) 41, a speaker 43, a headphone terminal 45, an external memory controller 47, line input terminal 49, a serial interface (I/F) 51, an EEPROM 53, and LCD 55, which are respectively connected to CPU 11 via a bus 37.

RAM 41 is used as a work area of CPU 11. EEPROM 53 stores a program to be executed by CPU 11, a parameter for the execution of that program, and the like as well as stores a compressed audio signal and the like in a non-volatile manner. The details of the data to be stored in EEPROM 53 will be described later. To external memory controller 47, a memory card 47A is connected. CPU 11 is capable of accessing memory card 47A via external memory controller 47 connected thereto.

AM/FM tuner 39 is a radio tuner and is connected to an antenna. AM/FM tuner 39 obtains an analog audio signal of a specific frequency from the electromagnetic waves received by the antenna and outputs the obtained audio signal to speaker 43 and codec 31. Moreover, although the case where the radio signal is an analog signal is described as an example here, the audio signal received may be a digital signal as well. In such a case, the digital signal encoded by compression may be decoded by encoder/decoder 35 and the decoded audio signal may be converted into an analog audio signal in codec 31.

Serial interface 51 is connected to a device which is capable of serial communication. CPU 11 is capable of communicating via serial interface 51 with a device connected thereto. Headphone terminal 45 has a headphone or an earphone and the like connected thereto and outputs an analog audio signal to them. Speaker 43 is placed on a reverse side which is the opposite of the front surface of body portion 3 on which LCD 55 is arranged, receives input of the analog audio signal, and outputs sound.

To codec 31, microphone 33 is connected, and the analog audio signal is inputted from microphone 33 while changeover switch 5 is switched to the first state and the analog audio signal is inputted from line input terminal 49 while changeover switch 5 is switched to the second state. In addition, the analog audio signal from AM/FM tuner 39 is inputted into codec 31. Codec 31 converts the inputted analog audio signal into a digital signal, and after a prescribed processing, outputs the audio signal which has undergone digitization to CPU 11.

Encoder/decoder 35 is controlled by CPU 11 to encode the audio signal outputted from codec 31 and generates sound data. In addition, encoder/decoder 35 is controlled by CPU 11 to decode sound data and generates an audio signal.

CPU 11 causes encoder/decoder 35 to encode the audio signal outputted from codec 31 and stores the encoded sound data in EEPROM 53 or in memory card 47A connected to external memory controller 47.

In addition, CPU 11 reads the sound data stored in EEPROM 53 or in memory card 47A connected to external memory controller 47, causes encoder/decoder 35 to decode, causes codec 31 to convert the decoded audio signal into an analog signal, and outputs the analog audio signal to speaker 43 or to a headphone connected to headphone terminal 45.

IC recorder 1 is provided with a reservation setting function and a timer sound recording function. The reservation setting function is the function of generating reservation data which includes a recording setting that defines the time period of a sound recording, the sound to be recorded, the compression method and such, and the timer sound recording function is the function of recording the data which is obtained by compressing the sound defined by the reservation data inputted during the time period defined by the reservation data using the compression method and format in the recording setting defined by the reservation data. Hereon, the description on the reservation data will be provided.

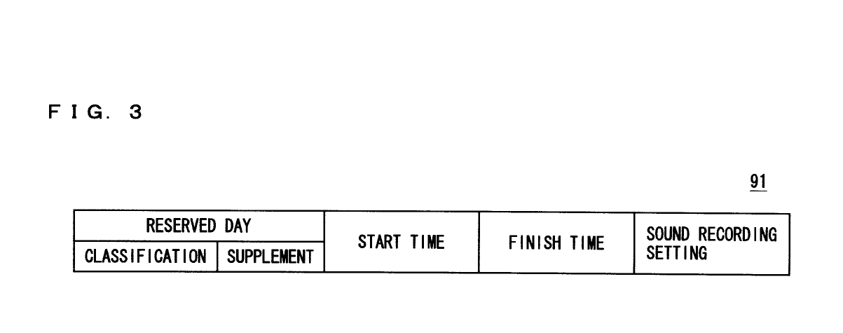

FIG. 3 is a diagram illustrating one example of a data format of the reservation data. Reservation data 91 includes the item of reserved day information, the item of the start time, the item of the finish time, and the item of a sound recording setting. The item of the reserved day information is the item to define the day to perform the sound recording and includes the item of a classification and the item of a supplement. In the item of the classification, one of the three kinds of classifications, “daily,” “weekly,” and “date,” for defining the day to perform the sound recording is set. In the item of the supplement, supplemental information for specifying the day to perform the sound recording is set according to the classification set in the item of the classification. The classification “daily” indicates that the day to perform the sound recording is specified for everyday, and when the classification “daily” is set in the item of the classification, nothing is set in the item of the supplement. The classification “weekly” indicates that the day to perform the sound recording is specified by a day of the week, and when the classification “weekly” is set in the item of the classification, a day of the week is set in the item of the supplement. Hereinafter, the day of the week being set in the item of the supplement in the case where the classification “weekly” is set in the item of the classification will be referred to as a reserved day of the week. The classification “date” indicates that the day to perform the sound recording is specified by a date, and when the classification “date” is set in the item of the classification, a date is set in the item of the supplement. Hereinafter, the date being set in the item of the supplement in the case where the classification “date” is set in the item of the classification will be referred to as a reserved date.

In the item of the start time, the time to start the sound recording is set, and in the item of the finish time, the time to finish the sound recording is set. In the item of the sound recording setting, the information to specify a sound source and the information to specify a compression method or a data format are set. The information to specify the sound source is one of AM/FM tuner 39, microphone 33, and line input terminal 49. In the case where AM/FM tuner 39 is set as the sound source, a channel for identifying a radio frequency will also be set.

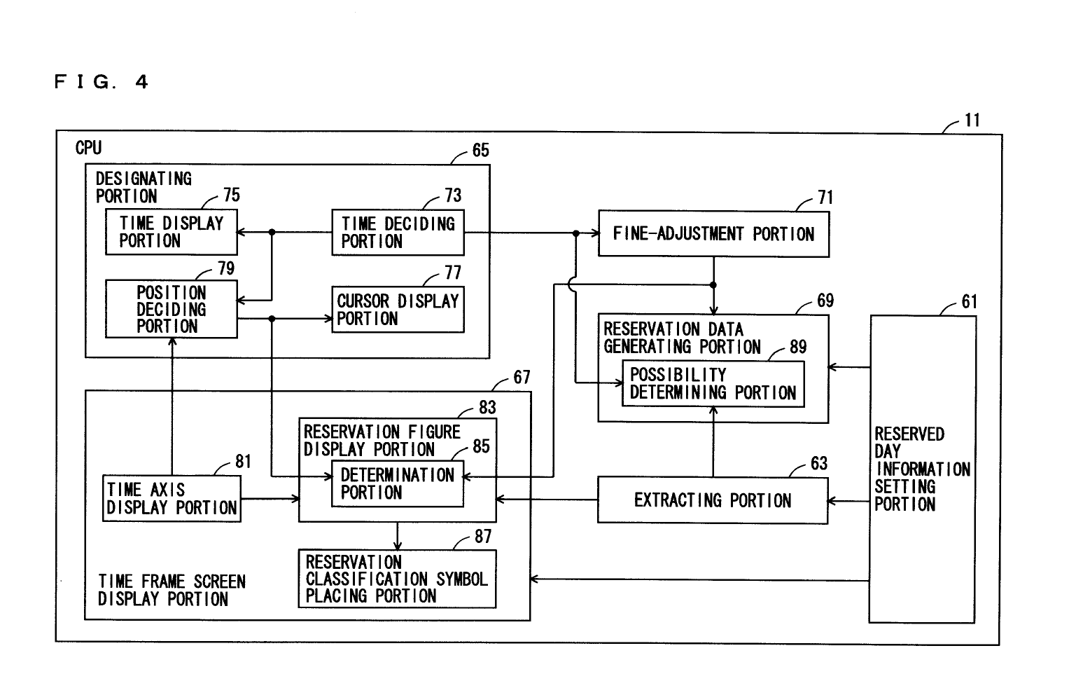

FIG. 4 is a block diagram showing an overview of a reservation setting function of a CPU along with data stored in an EEPROM. CPU 11 includes a reserved day information setting portion 61 to set reserved day information, an extracting portion 63 to extract reservation data, a designating portion 65, a fine-adjustment portion 71, a time frame screen display portion 67 to display a time frame screen, and a reservation data generating portion 69 to generate the reservation data.

Reserved day information setting portion 61 sets the reserved day information of the reservation data which is about to be generated. When the user presses reservation button 19, reserved day information setting portion 61 obtains the current date, generates a reserved day information setting screen which includes a calendar of the month of the year including the current date, and displays the reserved day information setting screen on LCD 55. The calendar is the chart in which all the dates of the month of the year that includes the current date are arranged by days of the week.

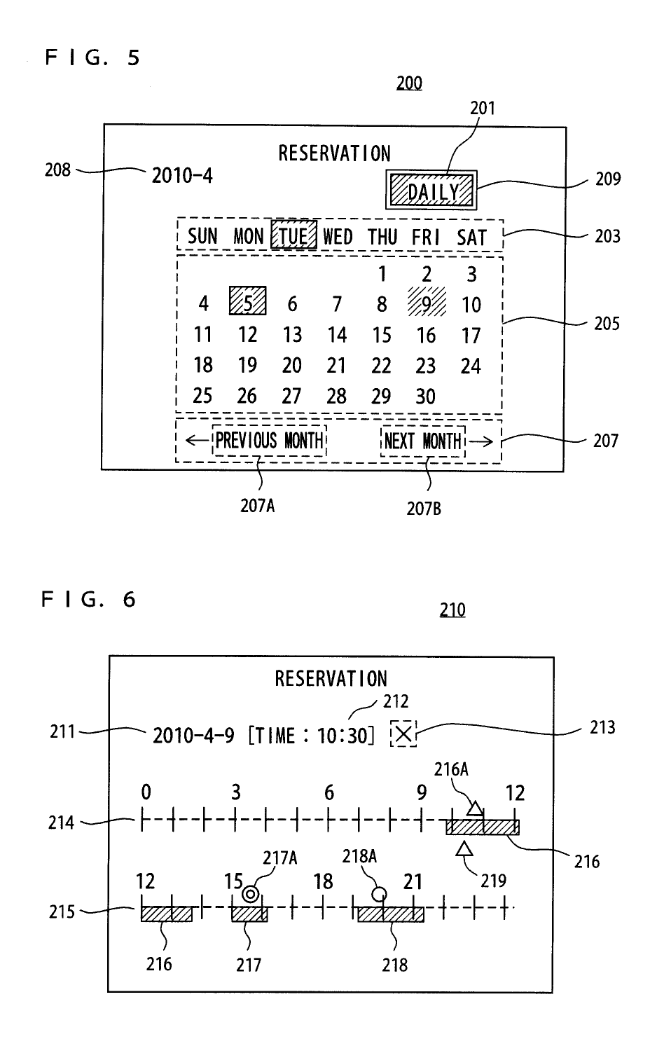

FIG. 5 is a diagram illustrating one example of a reserved day information setting screen. A reserved day information setting screen 200 includes an area 208 indicating the year and the month of the calendar to be displayed therein, an area 201 for designating the classification “daily,” an area 203 for designating the classification “weekly,” an area 205 for designating the classification “date,” an area 207 for changing the month of the year of the calendar being displayed, and a cursor 209. Moreover, the broken line in the diagram has been provided for the purpose of description and does not actually exist.

Area 205 for designating the classification “date” includes a calendar. In area 208 indicating the year and the month, the year and the month “2010-4” is displayed, indicating that the calendar being displayed in area 205 includes the dates of April of the year 2010.

Area 201 includes the character string of “DAILY” and indicates whether the reservation data in which the classification “daily” is set in the item of the classification exists or not. The display by inversion takes place if the reservation data in which the classification “daily” is set in the item of the classification exists, and if not, the display by inversion does not occur. Here, area 201 is displayed by inversion, which indicates that the reservation data in which the classification “daily” is set in the item of the classification does exist.

Area 203 for designating the classification “weekly” includes seven days of the week from Monday through Sunday and indicates whether or not the reservation data in which the classification “weekly” is set in the item of the classification exists. The display by inversion takes place if the reservation data exists in which the classification “weekly” is set in the item of the classification and in which the corresponding day of the week is set in the item of the supplement, and if not, the display by inversion does not occur. Here, the day of the week “TUE” included in area 203 is displayed by inversion, which indicates by hatching that the reservation data in which the classification “weekly” is set in the item of the classification and in which the day of the week “TUE” is set in the item of the supplement does exist.

Area 205 for designating the classification “date” includes a calendar. The dates in the calendar are each arranged according to the days of the week displayed in area 203. Area 205 also indicates whether or not the reservation data in which the classification “date” is set in the item of the classification exists. The display by inversion takes place if the reservation data exists in which the classification “date” is set in the item of the classification and in which the corresponding date is set in the item of the supplement, and if not, the display by inversion does not occur. Here, the dates “5” and “9” in the calendar are displayed by inversion, which indicates that the reservation data in which the classification “date” is set in the item of the classification exists for each of the fifth and the ninth of April of the year 2010.

Area 207 includes an area 207A which includes the character string of “PREVIOUS MONTH” and an area 207B which includes the character string of “NEXT MONTH.”

Reserved day information setting portion 61 causes cursor 209 to move within reserved day information setting screen 200 when a user presses up button 25A, down button 25B, right button 25C, and left button 25D while reserved day information setting screen 200 is being displayed. Reserved day information setting portion 61 decides on the classification “daily” if the user presses decide button 13 while cursor 209 is located at area 201, and outputs the decided classification “daily” to extracting portion 63, reservation data generating portion 69, and time frame screen display portion 67.

If the user presses decide button 13 while cursor 209 is located at any one of the seven days of the week within area 203, the classification “weekly” is decided, and the day of the week at which the cursor is located is decided to be the reserved day of the week. Reserved day information setting portion 61 outputs the decided classification “weekly” and the reserved day of the week as a set to extracting portion 63, reservation data generating portion 69, and time frame screen display portion 67.

If the user presses decide button 13 while cursor 209 is located at one of the dates inside area 205, the classification “date” is decided, and the date at which the cursor is located is decided to be the reserved date. Reserved day information setting portion 61 outputs the decided classification “date” and the reserved date as a set to extracting portion 63, reservation data generating portion 69, and time frame screen display portion 67.

If the user presses decide button 13 while cursor 209 is located at area 207A, a new reserved day information setting screen 200 is displayed which includes the calendar of the month of the year which is one month prior to the month of the year of the calendar being displayed on the existing reserved day information setting screen 200. If the user presses decide button 13 while cursor 209 is located at area 207B, a new reserved day information setting screen 200 is displayed which includes the calendar of the month of the year which is one month after the month of the year of the calendar being displayed on the existing reserved day information setting screen 200.

To extracting portion 63, one of the classification “daily,” the set of the classification “weekly” and the reserved day of the week, and the set of the classification “date” and the reserved date is inputted from reserved day information setting portion 61. When the classification “daily” is inputted from reserved day information setting portion 61, extracting portion 63 reads the reservation data in which the classification “daily” is set in the item of the classification, the reservation data in which the classification “weekly” is set in the item of the classification, and the reservation data in which the classification “date” is set in the item of the classification. Extracting portion 63 outputs all of the read reservation data to time frame screen display portion 67 and reservation data generating portion 69.

When the set of the classification “weekly” and the reserved day of the week is inputted from reserved day information setting portion 61, extracting portion 63 reads the reservation data in which the classification “daily” is set in the item of the classification, the reservation data in which the classification “weekly” is set in the item of the classification and in which a reserved day of the week is set in the item of the supplement, and the reservation data in which the classification “date” is set in the item of the classification and in which the day of the week of the date set in the item of the supplement is the same as the reserved day of the week. Extracting portion 63 outputs all of the read reservation data to time frame screen display portion 67 and reservation data generating portion 69.

When the set of the classification “date” and the reserved date is inputted from reserved day information setting portion 61, extracting portion 63 reads the reservation data in which the classification “daily” is set in the item of the classification, the reservation data in which the classification “weekly” is set in the item of the classification and in which the reserved day of the week set in the item of the supplement is the same as the day of the week of the reserved date, and the reservation data in which the classification “date” is set in the item of the classification and in which the reserved date set in the item of the supplement is the same as the reserved date being inputted from reserved day information setting portion 61. Extracting portion 63 outputs all of the read reservation data to time frame screen display portion 67 and reservation data generating portion 69.

When one of the classification “daily,” the set of the classification “weekly” and the reserved day of the week, and the set of the classification “date” and the reserved date is inputted from reserved day information setting portion 61, time frame screen display portion 67 generates a time frame screen and displays it on LCD 55. Time frame screen display portion 67 first displays the reserved day information on the time frame screen. The reserved day information is the reserved day which becomes the target of the setting of the reservation data on the time frame screen. More specifically, the reserved day information is the classification “daily” if the classification “daily” is inputted from reserved day information setting portion 61, the reserved day of the week if the set of the classification “weekly” and the reserved day of the week is inputted from reserved day information setting portion 61, or the reserved date if the set of the classification “date” and the reserved date is inputted from reserved day information setting portion 61.

Time frame screen display portion 67 includes a time axis display portion 81, a reservation figure display portion 83, and a reservation classification symbol placing portion 87. Time axis display portion 81 arranges a time axis that indicates time of one day on the time frame screen. Time axis display portion 81 outputs the position of a time axis within the time frame screen to designating portion 65. In the present embodiment, the resolution of LCD 55 is 144 DPI. Here, the time axis for twenty-four hours is divided into a first axis for the time between 0:00 and 12:00 and a second axis for the time between 12:00 and 24:00 arranged in two levels of top and bottom in the time frame screen. In addition, the length in the lateral direction of LCD 55 is set to be one inch so that the time represented by one dot corresponds to five minutes.

To reservation figure display portion 83, the position of a time axis within the time frame screen is inputted from time axis display portion 81 and reservation data is inputted from extracting portion 63. Reservation figure display portion 83 displays a reservation figure on the time axis arranged in the time frame screen based on the reservation data inputted from extracting portion 63. The reservation figure is the shape which represents the period between the start time and the finish time of the reservation data on the time axis. In other words, the reservation figure is the shape which indicates on the time axis the fact that the reservation data exists. Here, the reservation figure used is a rectangular shape. More specifically, reservation figure display portion 83 specifies the position on the time axis of each of the start time and the finish time being set in the reservation data and places on the time axis a rectangular reservation figure whose length in the lateral direction corresponds to the distance between the position of the start time on the time axis and the position of the finish time on the time axis. Reservation figure display portion 83 outputs the classification included in the reservation data and the position of the reservation figure on the time axis as a set to reservation classification symbol placing portion 87.

Since the reservation figure is displayed on the time axis, the user is able to determine from the figure whether the reservation data which has already been scheduled exists on the time axis or not. In addition, for the start time and the finish time of the reservation data about to be set, the user only needs to designate the positions on the time axis at which no reservation figure is placed so that setting can be made such that no overlapping with the already scheduled reservation data occurs.

Moreover, since the precision of the time axis arranged by time axis display portion 81 is five minutes as described above, when the start time or the finish time is not a multiple of five, the location on the time axis of the rounded time would be specified. More specifically, if the unit of the minutes of the start time is not a multiple of five, the start time is changed to the latest time which is before the start time and whose unit of the minutes is a multiple of five, and the position on the time axis of the start time after the change becomes a start point of the reservation figure; and if the unit of the minutes of the finish time is not a multiple of five, the finish time is changed to the earliest time which is after the finish time and whose unit of the minutes is a multiple of five, and the position on the time axis of the finish time after the change becomes an end point of the reservation figure.

To reservation classification symbol placing portion 87, the classification and the position on the time axis of the reservation figure are inputted as a set from reservation figure display portion 83. Reservation classification symbol placing portion 87 places a reservation classification symbol in a vicinity of the reservation figure. The reservation classification symbol is the symbol which represents the classification of the reservation data, and here, the reservation classification symbol representing the classification “daily” is shown by a double circle, the reservation classification symbol representing the classification “weekly” is shown by a circle, and the reservation classification symbol representing the classification “date” is shown by a triangle.

Since the reservation classification symbol is placed in the vicinity of the reservation figure, the user is able to recall from the reservation classification symbol the origin of the input of the sound recorded based on the reservation data corresponding to the reservation figure.

FIG. 6 is a diagram illustrating one example of a time frame screen. FIG. 6 shows a time frame screen 210 which is displayed in the case where decide button 13 is pressed after cursor 209 had been moved to the date “9” inside area 205 in reserved day information setting screen 200 shown in FIG. 5. Time frame screen 210 includes an area 211 to display reserved day information, an area 212 to display a display time, an area 213 to display setting possibility or impossibility, a first time axis 214, a second time axis 215, reservation figures 216 to 218, reservation classification symbols 216A to 218A, and a cursor 219.

Area 211 displays the reserved day information designated in reserved day information setting screen 200. Here, the reserved day information indicates the case where the reserved date “Apr. 9, 2010” is designated with the classification “date” so that “2010-4-9” is displayed in area 211. First time axis 214 includes time between 0:00 and 12:00, while second time axis 215 includes time between 12:00 and 24:00. First time axis 214 and second time axis 215 are arranged in two levels of top and bottom.

Area 212 displays the display time designated by the user. Cursor 219 is placed at the position corresponding to the display time on first time axis 214 or on second time axis 215. In FIG. 6, the display time is “10:30” so that cursor 219 is placed in the position indicating the time of 10:30 on first time axis 214.

Reservation FIG. 216 represents the time frame which starts at the position of the time of 9:50 on first time axis 214 and ends at the time of 13:40 on second time axis 215. Reservation classification symbol 216A of a triangle is placed above the part of reservation FIG. 216 disposed on first time axis 214, indicating the classification to be “date.” Therefore, reservation FIG. 216 and reservation classification symbol 216A together indicate that there is the reservation data having the reserved day information of the classification “date” and the reserved date of “Apr. 9, 2010” whose start time is approximately 9:50 at the earliest and whose finish time is 13:40 at the latest.

Reservation FIG. 217 represents the time frame which starts at the position of the time of 15:00 and ends at the time of 16:20 on second time axis 215. Reservation classification symbol 217A of a double circle is placed above reservation FIG. 217, indicating the classification to be “daily.” Therefore, reservation FIG. 217 and reservation classification symbol 217A together indicate that there is the reservation data having the reserved day information of the classification “daily” whose start time is approximately 15:00 at the earliest and whose finish time is 16:20 at the latest.

Reservation FIG. 218 represents the time frame which starts at the position of the time of 18:20 and ends at the time of 21:20 on second time axis 215. Reservation classification symbol 218A of a circle is placed above reservation FIG. 218, indicating the classification to be “weekly.” Therefore, reservation FIG. 218 and reservation classification symbol 218A together indicate that there is the reservation data having the reserved day information of the classification “weekly” and the reserved day of the week of “FRI” whose start time is approximately 18:20 at the earliest and whose finish time is 21:20 at the latest.

Area 213 displays a mark which indicates whether or not it is possible to set the display time being displayed in area 212 as the start time or the finish time of the reservation data which is about to be set. If the setting is possible, the mark of a circle is displayed, and if the setting is impossible, the mark of an X is displayed. Here, the display time is “10:30” and thus the mark of an X indicating the impossibility of setting is displayed, as is seen by the fact that the time specified by the position of cursor 219 overlaps the time frame of reservation FIG. 216.

Designating portion 65 designates any given position on first and second time axes 214 and 215 displayed on time frame screen 210. Designating portion 65 includes a time deciding portion 73, a time display portion 75, a position deciding portion 79, and a cursor display portion 77. Time deciding portion 73 decides the display time and outputs the decided display time to position deciding portion 79, time display portion 75, fine-adjustment portion 71, and a determination portion 85 to be described later. Time deciding portion 73 decides as the display time the time which is closest to the current time at the point in time in the stage that time frame screen display portion 67 displayed time frame screen 210 and which has a value of minute that is a multiple of five. Furthermore, time deciding portion 73 decides the display time to be the time derived by adding five minutes to the current display time when the user presses right button 25C, and decides the display time to be the time derived by subtracting five minutes from the current display time when the user presses left button 25D.

When the display time is inputted from time deciding portion 73, time display portion 75 displays the inputted display time in area 212 of time frame screen 210. To position deciding portion 79, a position within time frame screen 210 of each of first and second time axes 214 and 215 is inputted from time axis display portion 81, and the display time is inputted from time deciding portion 73. When the display time is inputted from time deciding portion 73, position deciding portion 79 decides the position on first and second time axes 214 and 215 corresponding to the inputted display time to be the cursor position, and outputs the decided cursor position to cursor display portion 77. When the cursor position is inputted from position deciding portion 79, cursor display portion 77 displays cursor 219 at the cursor position on first and second time axes 214 and 215 being displayed on time frame screen 210. Thus, it is possible to notify the user of the display time using the position of cursor 219 displayed on first and second time axes 214 and 215.

Fine-adjustment portion 71 receives the input of the display time from time deciding portion 73 and decides on the adjusted time which is the display time that has been fine-adjusted. Since the display time decided by time deciding portion 73 is time indicated in unit of five minutes, fine-adjustment portion 71 fine-adjusts the display time in unit of one minute. Fine-adjustment portion 71 updates the display time to the value derived by adding one minute to the current display time when the user presses up button 25A, and updates the display time to the value derived by subtracting one minute from the current display time when the user presses down button 25B. Fine-adjustment portion 71 rewrites the display time displayed in area 212 of time frame screen 210 with the display time after the fine-adjustment as well as outputs the display time after fine-adjustment to determination portion 85 and reservation data generating portion 69. Thus, the user is able to designate the display time in the unit of minute, while at the same time, it becomes possible to notify the user of the display time in the unit of minutes even in the case where LCD 55 is incapable of displaying first and second time axes 214 and 215 with per-minute precision. As a result, even when LCD 55 is small in size and the display resolution is small, the start time and the finish time can be designated by the unit of a minute.

Reservation figure display portion 83 includes determination portion 85. To determination portion 85, the cursor position is inputted from position deciding portion 79 and the display time after fine-adjustment is inputted from fine-adjustment portion 71. If a reservation figure that overlaps the cursor position exists on a time axis, reservation figure display portion 83 alters the mode of display for the reservation figure overlapping the cursor position. The alteration of the mode of display includes the alteration in the brightness of the reservation figure, blinking, and the alteration in color, for instance. Here, the case where the brightness is heightened will be described as an example. Consequently, the user is notified of the fact that the time specified by the cursor position cannot be set as the start time or the finish time of the reservation data. In the case where the display time after fine-adjustment is inputted from fine-adjustment portion 71, or in other words, when the user presses up button 25A or down button 25B and the display time is fine-adjusted, however, the mode of display for the reservation figure which had been altered is returned to the original state when the display time after fine-adjustment is no longer included in the reserved time frame between the start time and the finish time of the reservation data of the reservation figure being displayed with heightened brightness among the reservation data inputted from extracting portion 63. This is because new reservation data can be set if the display time is not included in the reserved time frame as a result of the fine-adjustment of the display time.

Reservation data generating portion 69 generates reservation data and stores the generated reservation data in EEPROM 53. Reservation data generating portion 69 sets the reserved day information inputted from reserved day information setting portion 61 in the item of the reserved day information of the reservation data. In addition, reservation data generating portion 69 displays a sound recording setting screen on LCD 55, accepts sound recording setting information such as the information specifying a sound source and the information specifying a compression method or a data format, and sets the accepted sound recording setting information in the item of the sound recording setting.

Furthermore, reservation data generating portion 69 decides the start time and the finish time based on the display time inputted from time deciding portion 73 or fine-adjustment portion 71, sets the decided start time in the item of the start time in the reservation data, and sets the decided finish time in the item of the finish time in the reservation data.

Reservation data generating portion 69 includes a possibility determining portion 89 in order to decide the start time and the finish time. Possibility determining portion 89 selects the display time after fine-adjustment over the display time inputted from time deciding portion 73 as an object of processing if the display time after fine-adjustment is inputted from fine-adjustment portion 71 and selects the display time inputted from time deciding portion 73 as the object of processing if the display time after fine-adjustment is not inputted from fine-adjustment portion 71. Possibility determining portion 89 receives the input of reservation data from extracting portion 63 and determines the existence of the reservation data which includes the display time being selected as the object of processing between the start time and the finish time among the reservation data. If the reservation data which includes the display time being selected as the object of processing between the start time and the finish time exists among the reservation data, possibility determining portion 89 determines the setting to be impossible, and if no such reservation data exists, it determines the setting to be possible. Possibility determining portion 89 displays the mark of a circle in area 213 of time frame screen 210 when it determines the setting to be possible, and it displays the mark of an X in area 213 of time frame screen 210 when it determines the setting to be impossible.

At the stage in which time frame screen 210 is being displayed on LCD 55, if the user provides operation portion 7 with an instruction to set the start time, for instance, by pressing decide button 13, and provided that possibility determining portion 89 has determined the setting to be possible, reservation data generating portion 69 decides the display time after fine-adjustment to be the start time if the display time after fine-adjustment is inputted from fine-adjustment portion 71 and decides the display time inputted from time deciding portion 73 to be the start time if the display time after fine-adjustment is not inputted from fine-adjustment portion 71, and sets the decided start time in the item of the start time of the reservation data. In addition, at the stage in which time frame screen 210 is being displayed on LCD 55, if the user provides operation portion 7 with an instruction to set the finish time, for instance, by pressing decide button 13 after the start time has been decided, and provided that possibility determining portion 89 has determined the setting to be possible, reservation data generating portion 69 decides the display time after fine-adjustment to be the finish time if the display time after fine-adjustment is inputted from fine-adjustment portion 71 and decides the display time inputted from time deciding portion 73 to be the finish time if the display time after fine-adjustment is not inputted from fine-adjustment portion 71, and sets the decided finish time in the item of the finish time of the reservation data.

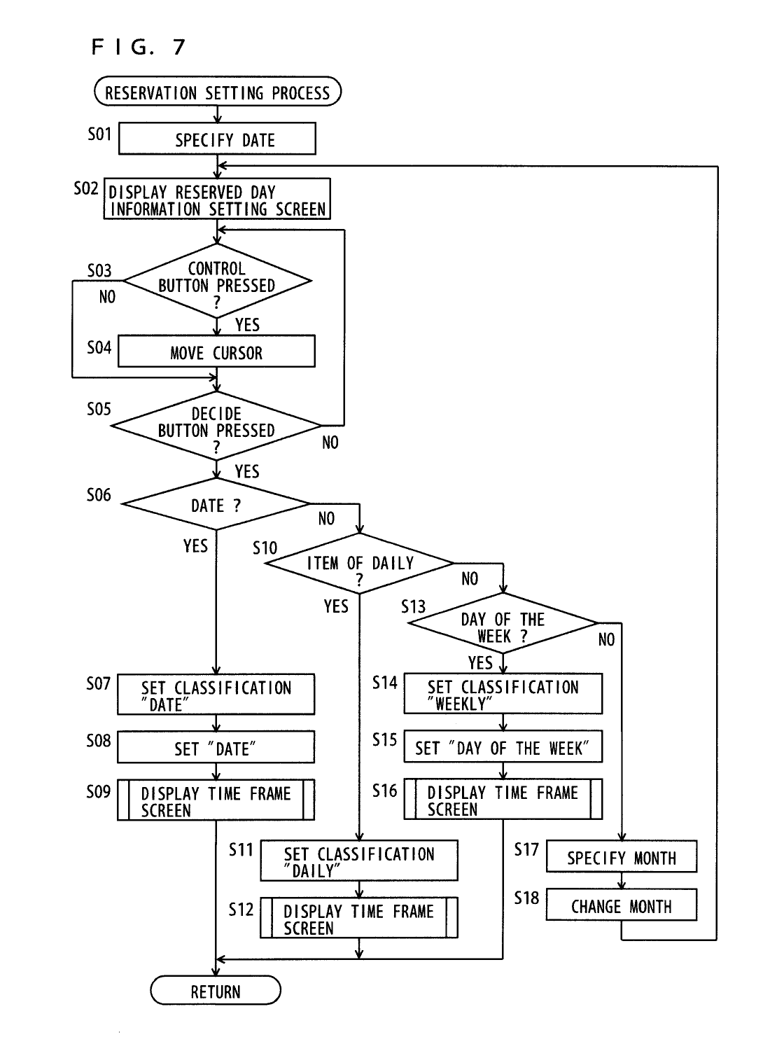

FIG. 7 is a flow chart showing one example of the flow of a reservation setting process. The reservation setting process is the process executed by CPU 11 when CPU 11 executes a reservation program stored in EEPROM 53. CPU 11 specifies the current date (step S01). In the next step S02, reserved day information setting screen 200 shown in FIG. 5 is displayed.

Then, it is determined whether control button 25 has been pressed or not (step S03). If control button 25 has been pressed, the process proceeds to a step S04, but if not, the process proceeds to a step S05. The process proceeds to step S04 when one of up button 25A, down button 25B, right button 25C, and left button 25D included in control button 25 is pressed. In step S04, a cursor is moved within reserved day information setting screen 200 displayed in step S02 according to the pressing of control button 25 pressed in step S03. The cursor is moved upward when up button 25A is pressed, the cursor is moved downward when down button 25B is pressed, the cursor is moved to the right when right button 25C is pressed, and the cursor is moved to the left when left button 25D is pressed. In the next step S05, it is determined whether decide button 13 has been pressed or not. If decide button 13 has been pressed, the process proceeds to a step S06, but if not, the process goes back to step S03. Thus, the pressing of control button 25 is accepted and the cursor is moved within reserved day information setting screen 200 until decide button 13 is pressed.

At step S06, at a step S10, at a step S13, and at a step S17, the process diverges based on the position of the cursor at the time point in which decide button 13 is pressed in step S05. In step S06, if the position of the cursor is in area 205 for designating the classification “date” within reserved day information setting screen 200, the process proceeds to a step S07. In step S10, if the position of the cursor is in area 201 for designating the classification “daily” within reserved day information setting screen 200, the process proceeds to a step S11. In step S13, if the position of the cursor is in area 203 for designating the classification “weekly” within reserved day information setting screen 200, the process proceeds to a step S14.

In step S17, if the position of the cursor is in an area 207 for changing the month of the year within reserved day information setting screen 200, the process proceeds to a step S18. In step S18, the month of the year is changed, and the process goes back to step S02. In step S02, the reserved day information setting screen including the following month or the previous month is displayed.

In step S07, the classification “date” is set in the item of the classification in the reservation data. Then, in the item of the supplement in the reservation data, the date corresponding to the position of the cursor within reserved day information setting screen 200 at the time decide button 13 was pressed in step S05 is set (step S08). Thereafter, a time frame screen display process is executed (step S09), and the reservation setting process is terminated.

In step S11, the item of the classification in the reservation data is set to the classification “daily.” Then, the time frame screen display process is executed (step S12), and the reservation setting process is terminated. In a step S14, the classification “weekly” is set in the item of the classification in the reservation data. Then, in the item of the supplement in the reservation data, the day of the week corresponding to the position of the cursor within reserved day information setting screen 200 at the time decide button 13 was pressed in step S05 is set (step S15). Thereafter, the time frame screen display process is executed (step S16), and the reservation setting process is terminated.

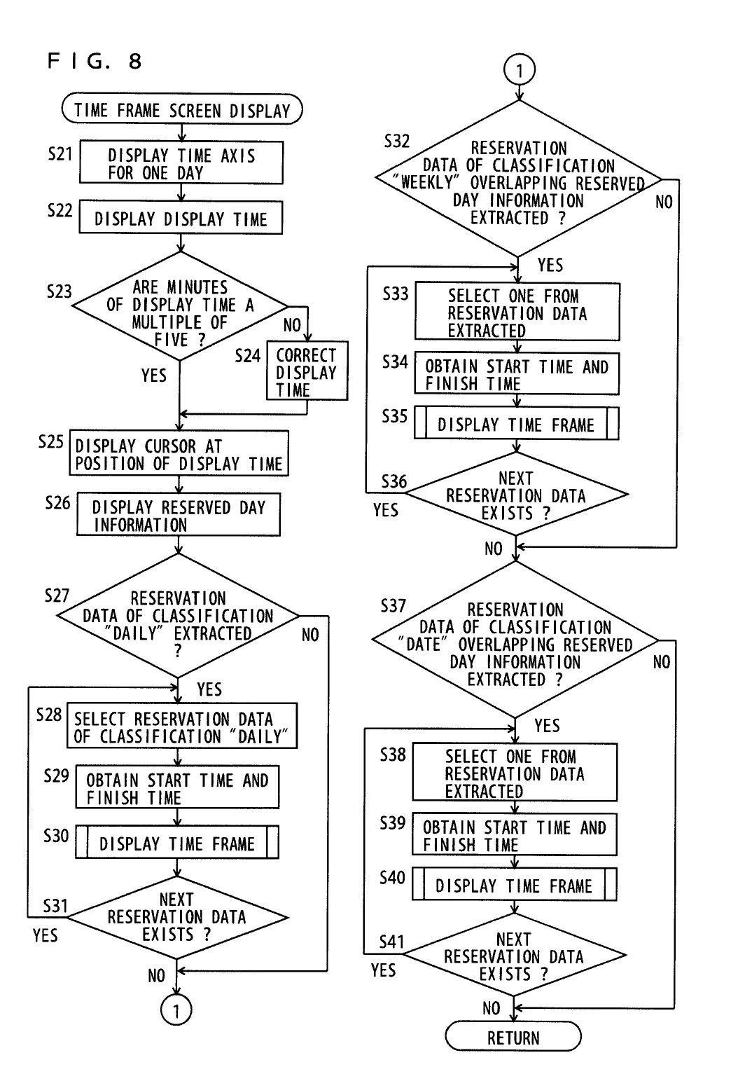

FIG. 8 is a flow chart showing one example of the flow of a time frame screen display process. The time frame screen display process is the process executed in a step S09, in a step S12, or in a step S16 shown in FIG. 7, and is the process to display time frame screen 210 shown in FIG. 6. First, a time axis of one day is displayed (step S21). Here, first time axis 214 and second time axis 215 are displayed.

In the next step S22, the current time is set as the display time, and the display time is displayed in area 212. In a step S23, it is determined whether the unit of the minutes of the display time is a multiple of five or not. If the unit of the minutes of the display time is a multiple of five, the process proceeds to a step S25, but if not, the process proceeds to a step S24. In step S24, the display time is corrected, and the process proceeds to step S25. The display time is corrected by changing the unit of the minutes of the display time to an integer part derived by division by five. In step S25, a cursor is displayed at the position corresponding to the display time on first time axis 214 and second time axis 215 displayed in step S21.

In the next step S26, reserved day information is displayed in area 211 of time frame screen 210. If the classification of the reserved day information is the classification “date,” the reserved date of the reserved day information is displayed in area 211. If the classification of the reserved day information is the classification “daily,” the character string of “DAILY” is displayed in area 211. If the classification of the reserved day information is the classification “weekly,” the reserved day of the week of the reserved day information is displayed in area 211.

In a step S27, the reservation data whose classification is “daily” is extracted. The reservation data in which the classification “daily” is set in the item of the classification of the reservation data is extracted from among the reservation data stored in EEPROM 53. If the reservation data in which the classification “daily” is set in the item of the classification of the reservation data is extracted, the process proceeds to a step S28, but if not, the process proceeds to a step S32.

In step S28, from among the reservation data extracted in step S27, one is selected. Then, the start time and the finish time being set respectively in the item of the start time and in the item of the finish time in the reservation data are obtained (step S29). Thereafter, a time frame display process is executed. The time frame display process will be described later. In the next step S31, it is determined whether or not the reservation data which has not yet been selected in step S28 exists among the reservation data extracted in step S27. If the reservation data which has not yet been selected exists, the process goes back to step S28, but if it does not exist, the process proceeds to step S32.

In step S32, the reservation data having the classification “weekly” which overlaps the reserved day information of the reservation data being generated is extracted. If the classification of the reserved day information is the classification “date,” the day of the week of the reserved date set in the item of the supplement in the reservation data being generated is specified, and the reservation data in which the classification “weekly” is set in the item of the classification and in which the specified day of the week is set in the item of the supplement is extracted. If the classification of the reserved day information is the classification “weekly,” the reservation data is extracted in which the classification “weekly” is set in the item of the classification and in which the same reserved day of the week is set as the reserved day of the week being set in the item of the supplement in the reservation data being generated. If the classification of the reserved day information is the classification “daily,” all the reservation data is extracted in which the classification “daily” is set in the item of the classification.

In a step S33, from among the reservation data extracted in step S32, one is selected. Then, the start time and the finish time being set respectively in the item of the start time and in the item of the finish time in the reservation data are obtained (step S34). Thereafter, the time frame display process is executed. The time frame display process will be described later. In the next step S36, it is determined whether or not the reservation data which has not yet been selected in step S33 exists among the reservation data extracted in step S32. If the reservation data which has not yet been selected exists, the process goes back to step S33, but if it does not exist, the process proceeds to a step S37.

In step S37, the reservation data having the classification “date” which overlaps the reserved day information of the reservation data being generated is extracted. If the classification of the reserved day information is the classification “date,” the reservation data is extracted in which the classification “date” is set in the item of the classification and in which the reserved date being set in the item of the supplement in the reservation data being generated is set in the item of the supplement. If the classification of the reserved day information is the classification “weekly,” the reservation data is extracted in which the classification “date” is set in the item of the classification and in which the date set in the item of the supplement is the same as the reserved day of the week being set in the item of the supplement in the reservation data being generated. If the classification of the reserved day information is the classification “daily,” all the reservation data is extracted in which the classification “daily” is set in the item of the classification.

In a step S38, from among the reservation data extracted in step S37, one is selected. Then, the start time and the finish time being set respectively in the item of the start time and in the item of the finish time in the reservation data are obtained (step S39). Thereafter, the time frame display process is executed (step S40). In the next step S41, it is determined whether or not the reservation data which has not yet been selected in step S38 exists among the reservation data extracted in step S37. If the reservation data which has not yet been selected exists, the process goes back to step S38, but if it does not exist, the process goes back to the reservation setting process.

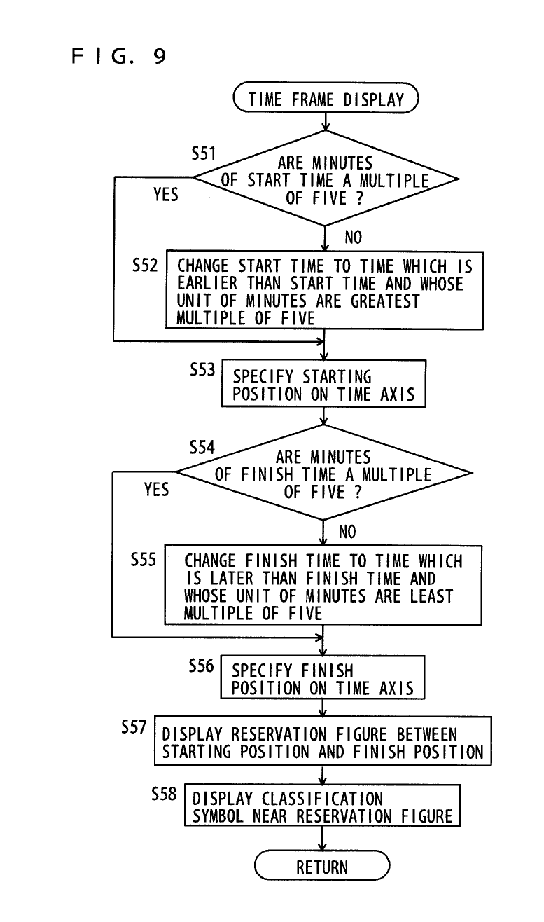

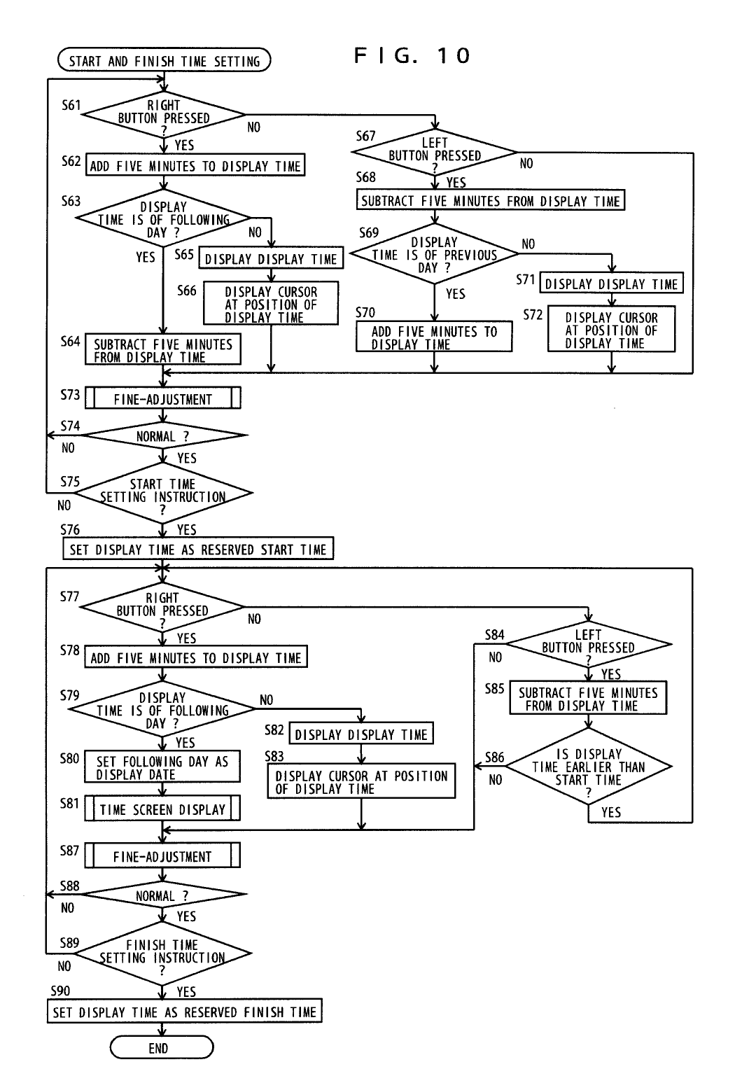

FIG. 9 is a flow chart showing one example of the flow of a time frame display process. The time frame display process is the process executed in a step S30, in a step S35, and in step S40 shown in FIG. 8. In a step S51, it is determined whether the unit of the minutes of the start time is a multiple of five or not. If the unit of the minutes of the start time is a multiple of five, the process proceeds to a step S53, but if not, the process proceeds to a step S52. In step S52, the start time is changed to the time which is earlier than the start time and whose unit of the minutes is the greatest multiple of five, and the process proceeds to step S53. In step S53, the starting position on a time axis that corresponds to the start time is specified.

In the next step S54, it is determined whether the unit of the minutes of the finish time is a multiple of five or not. If the unit of the minutes of the finish time obtained is a multiple of five, the process proceeds to a step S56, but if not, the process proceeds to a step S55. In step S55, the finish time is changed to the time which is later than the finish time and whose unit of the minutes is the least multiple of five, and the process proceeds to step S56. In step S56, the finish position on a time axis that corresponds to the finish time is specified.

In a step S57, a reservation figure is displayed between the starting position specified in step S53 and the finish position specified in step S56. In the next step S58, a reservation classification symbol is displayed in the vicinity of the reservation figure displayed in step S57, and the process goes back to the time frame screen display process. The reservation classification symbol is displayed that corresponds to the classification set in the item of the classification in the reservation data being generated. If the classification “daily” is set, the reservation classification symbol represented by a double circle is displayed; if the classification “weekly” is set, the reservation classification symbol represented by a circle is displayed; and if the classification “date” is set, the reservation classification symbol represented by a triangle is displayed.

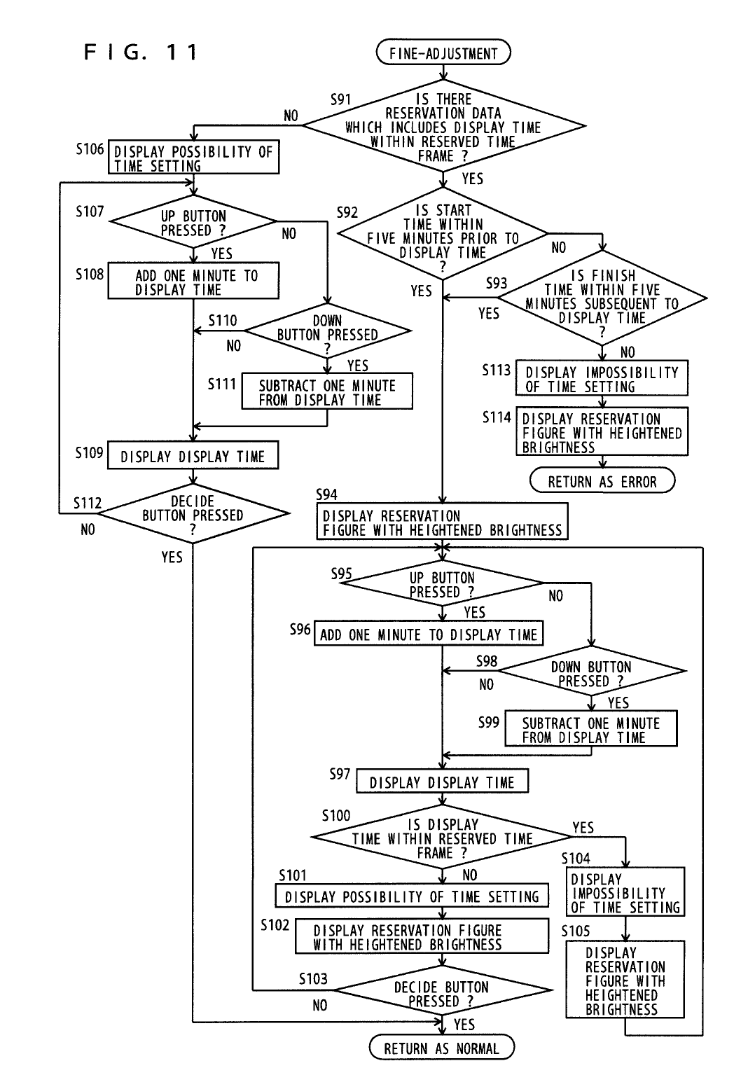

FIG. 10 is a flow chart showing one example of the flow of a start and finish time setting process. The start and finish time setting process is the process executed after time frame screen 210 shown in FIG. 6 is displayed on LCD 55. In a step S61, it is determined whether right button 25C has been pressed or not. If right button 25C has been pressed, the process proceeds to a step S62, but if not, the process proceeds to a step S67.

In step S62, the display time is updated to the value derived by adding five minutes thereto. In a step S63, it is determined whether the display time belongs to the following day or not. If the display time indicates a time of the following day, the process proceeds to a step S64, but if not, the process proceeds to a step S65. In step S64, the display time is updated to the value derived by subtracting five minutes therefrom, and the process proceeds to a step S73. In step S65, the display time is displayed in area 212 of time frame screen 210. Next, in a step S66, a cursor is displayed at the position of the display time on first time axis 214 and second time axis 215 in time frame screen 210, and the process proceeds to step S73.

On the other hand, in step S67, it is determined whether left button 25D has been pressed or not. If left button 25D has been pressed, the process proceeds to a step S68, but if not, the process proceeds to step S73. In step S68, the display time is updated to the value derived by subtracting five minutes therefrom. In a step S69, it is determined whether the display time belongs to the previous day or not. If the display time is a time from the previous day, the process proceeds to a step S70, but if not, the process proceeds to a step S71. In step S70, the display time is updated to the value derived by adding five minutes thereto, and the process proceeds to step S73. In step S71, the display time is displayed in area 212 of time frame screen 210. In a step S72, a cursor is displayed at the position of the display time on first time axis 214 and second time axis 215 in time frame screen 210, and the process proceeds to step S73.

In step S73, a fine-adjustment process is executed. While the details of the fine-adjustment process will be described later, it is the process of determining whether or not it is possible to set the display time as a start time or a finish time. If the setting is possible, “normal” is returned as a return value, and if the setting is impossible, “error” is returned as the return value. In a step S74, the result of the fine-adjustment process is determined from the return value. If it is an error, the process goes back to step S61, and if it is normal, the process proceeds to a step S75. In step S75, it is determined whether a start time setting instruction has been accepted or not. A start time setting instruction is accepted when the user presses decide button 13. If the start time setting instruction has been accepted, the process proceeds to a step S76, but if not, the process goes back to step S61. In step S76, the display time is set in the item of the start time in the reservation data, and the process proceeds to a step S77.

The process in step S77 through step S79 and in a step S82 and in a step S83 is the same as that in step S61 through step S63 and in step S65 and in step S66. In step S79, in the case where the display time is determined to be of the following day, the display date is updated with the display date of the following day (step S80), time frame screen 210 shown in FIG. 6 is displayed (step S81), and the process proceeds to a step S87.

In a step S84, it is determined whether left button 25D has been pressed or not. If left button 25D has been pressed, the process proceeds to a step S85, but if not, the process proceeds to step S87. In step S85, the display time is updated with the value derived by subtracting five minutes therefrom. Then, in a step S86, it is determined whether or not the display time is a time that is earlier than the start time set in step S76. If the display time is earlier than the start time, the process goes back to step S77, but if not, the process proceeds to step S87.

In step S87, the fine-adjustment process is executed. In a step S88, the result of the fine-adjustment process is determined from the return value, and if it is an error, the process goes back to step S77, and if it is normal, the process proceeds to a step S89. In step S89, it is determined whether a finish time setting instruction has been accepted or not. A finish time setting instruction is accepted when the user presses decide button 13. If the finish time setting instruction has been accepted, the process proceeds to a step S90, but if not, the process goes back to step S77. In step S90, the display time is set in the item of the finish time in the reservation data, and the process is terminated.

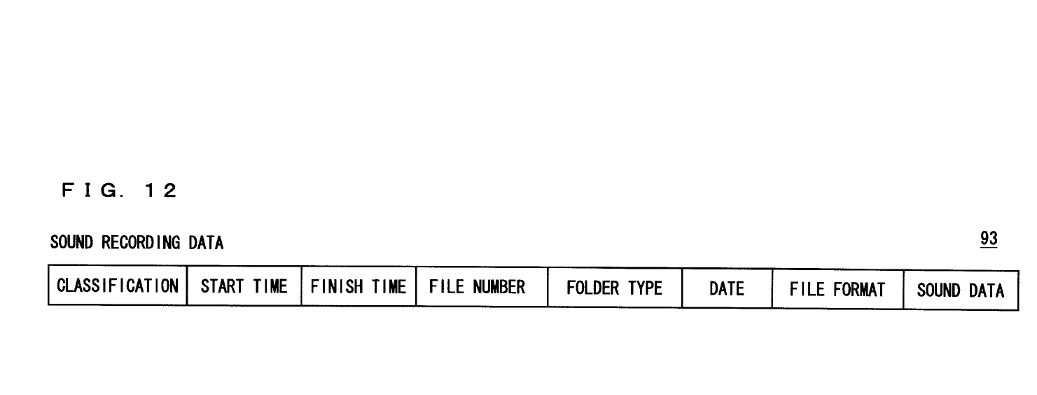

FIG. 11 is a flow chart showing one example of the flow of the fine-adjustment process. The fine-adjustment process is the process executed in step S73 and in step S87 of FIG. 10. In a step S91, it is determined whether the reservation data which includes the display time within the reserved time frame exists or not. It is determined whether or not the reservation data which includes the display time within the reserved time frame between the start time and the finish time exists among the reservation data whose reservation figures are displayed in time frame screen 210. If such reservation data exists, it is set as an object of processing, and the process proceeds to a step S92, but if not, the process proceeds to a step S113.

In step S92, it is determined whether the start time of the reservation data set to be the object of processing in step S91 is within the five minutes prior to the display time or not. If the start time of the reservation data is within the five minutes prior to the display time, the process proceeds to a step S94, but if not, the process proceeds to a step S93. In step S93, it is determined whether the finish time of the reservation data set to be the object of processing in step S91 is within the five minutes subsequent to the display time or not. If the finish time of the reservation data is within the five minutes subsequent to the display time, the process proceeds to step S94, but if not, the process proceeds to step S113.

In step S94, the reservation figure corresponding to the reservation data set as the object of processing is displayed with its brightness heightened. Thus, the user is notified of the need for fine-adjustment. A message such as “Please make the fine-adjustment” may be displayed, for instance.

In a step S95, it is determined whether up button 25A has been pressed or not. If up button 25A has been pressed, the process proceeds to a step S96, but if not, the process proceeds to step S96. In step S98, the display time is updated to the value derived by adding one minute thereto, and the process proceeds to a step S97. In step S98, it is determined whether down button 25B has been pressed or not. If down button 25B has been pressed, the process proceeds to a step S99, but if not, the process proceeds to step S97. In step S99, the display time is updated to the value derived by subtracting one minute therefrom, and the process proceeds to step S97.

In step S97, the display time is displayed in area 212 of time frame screen 210. In the next step S100, it is determined whether or not the display time is within the reserved time frame of the reservation data set to be the object of processing. If the display time is within the reserved time frame, the process proceeds to a step S101, but if not, the process proceeds to a step S104. In step S104, the impossibility of time setting is displayed. For instance, an error message is displayed on LCD 55. In a step S105, the reservation figure corresponding to the reservation data set as the object of processing is displayed with its brightness heightened, and the process goes back to step S95.

In step S101, the possibility of time setting is displayed. For instance, a message indicating that it is possible to set the display time is displayed on LCD 55. In the next step S102, the brightness of the reservation figure corresponding to the reservation data set as the object of processing is returned to the normal display mode. Then, it is determined whether decide button 13 has been pressed or not (step S103). If decide button 13 has been pressed, “normal” is set as the return value and the process goes back to the start and finish time setting process, but if decide button 13 is not pressed, the process goes back to step S95.

On the other hand, the case in which the process proceeds to a step S106 is the case where the reservation data which includes the display time within the reserved time frame does not exist. In step S106, the possibility of time setting is displayed. The process in step S107 through step S111 is the same as that in step S95 through step S99, respectively. In a step S109, the display time is displayed in time frame screen 210, and thereafter in a step S112, it is determined whether decide button 13 has been pressed or not. If decide button 13 has been pressed, “normal” is set as the return value and the process goes back to the start and finish time setting process, but if decide button 13 is not pressed, the process goes back to step S107.

The case in which the process proceeds to step S113 is the case where the reservation data which includes the display time within the reserved time frame exists, the reservation data whose start time is within the five minutes prior to the display time or the reservation data whose finish time is within the five minutes subsequent to the display time does not exist. In such a case, the display time would be included in the reserved time frame even when the display time is fine-adjusted so that an error process is executed. More specifically, the impossibility of time setting is displayed in step S113. For instance, an error message is displayed on LCD 55. Then, in a step S114, the reservation figure corresponding to the reservation data set as the object of processing is displayed with its brightness heightened, “error” is set as the return value, and the process goes back to the start and finish time setting process.

Playback Function

IC recorder 1 according to the present embodiment performs a sound recording according to the reservation data and stores the sound recording data in EEPROM 53. More specifically, when the current time reaches the start time of the reservation data, the sound recording is made according to the sound recording setting of the reservation data, and the sound recording data is stored in EEPROM 53.

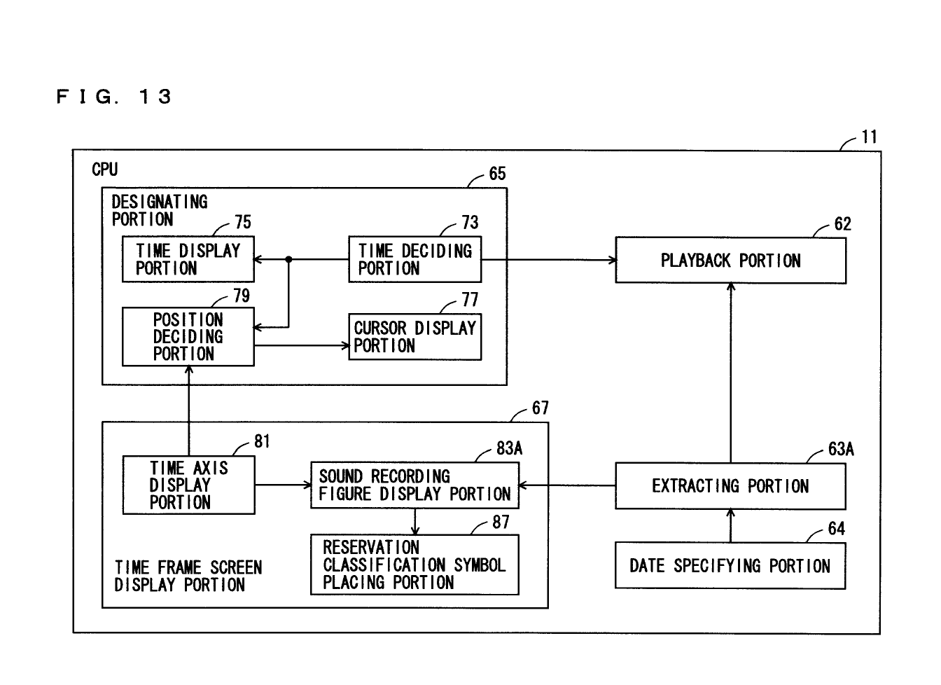

FIG. 12 is a diagram illustrating one example of a data format of sound recording data. Sound recording data 93 includes the item of a classification, the item of a start time, the item of a finish time, the item of a file number, the item of a folder type, the item of a date, the item of a file format, and the item of sound data. The item of the classification is set in the case where sound recording data is recorded according to reservation data 91, and the classification that is set in the item of the classification in reservation data 91 is set. In the item of the start time, the time at which storing of the sound data was started is set; in the item of the finish time, the time at which the storing of the sound data was finished is set; in the item of the file number, the number for identifying the file of the stored sound data is set; in the item of the folder type, the name for identifying the folder in which the file of the stored sound data is stored is set; the item of the date, the date on which the sound data was recorded is set; and in the item of the file format, the format of the file of the sound data is set. In the item of the sound data, the stored sound data is set.

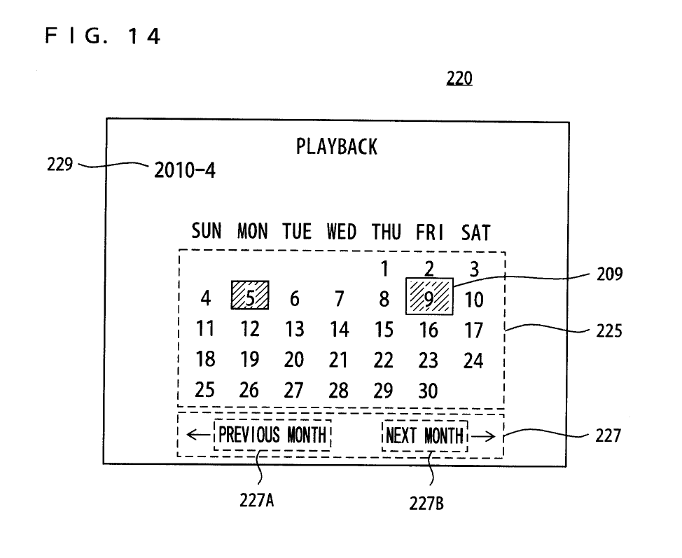

FIG. 13 is a block diagram showing one example of an overview of a playback setting function of the CPU. It differs from the function shown in FIG. 4 in that reserved day information setting portion 61, reservation data generating portion 69, and fine-adjustment portion 71 are deleted, reservation figure display portion 83 is changed to a sound recording figure display portion 83A, extracting portion 63 is changed to an extracting portion 63A, and a playback portion 62 and a date specifying portion 64 are added. The function of other parts is the same as the function shown in FIG. 4 so that the description will not be repeated here.

Date specifying portion 64 obtains the current date when the user specifies a day and presses search button 21 in order to search for the sound recording data, generates a sound recording confirmation screen which includes the calendar of the month of the year including the current date, and displays the sound recording confirmation screen on LCD 55.

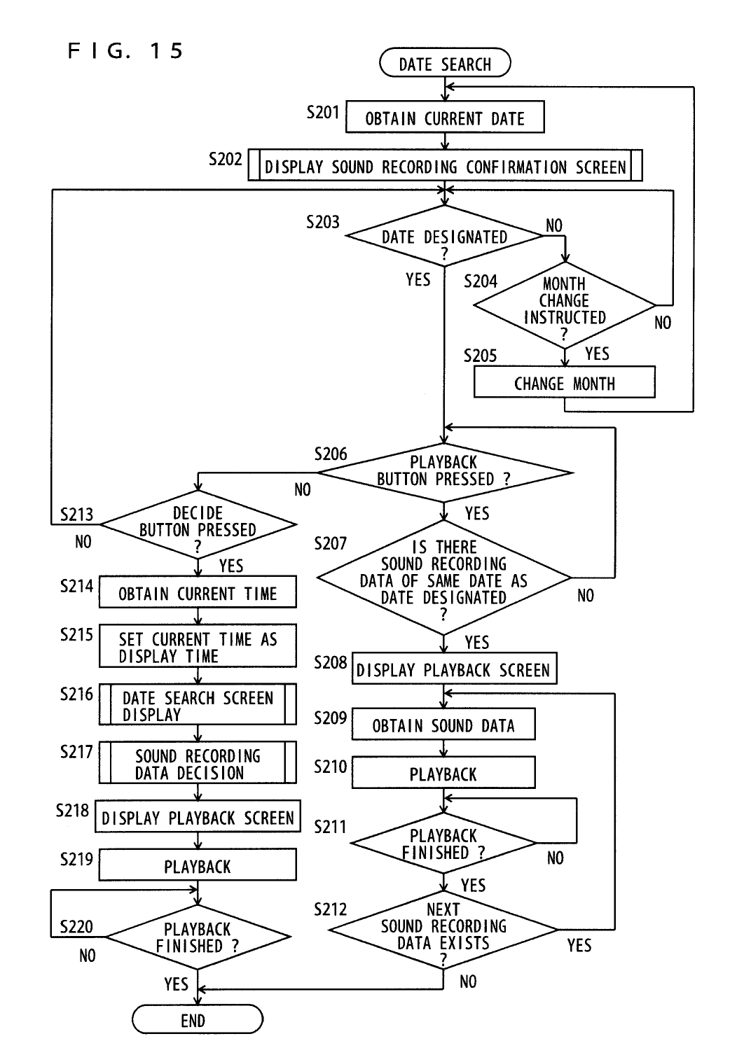

FIG. 14 is a diagram illustrating one example of the sound recording confirmation screen. A sound recording confirmation screen 220 includes an area 229 indicating the year and the month of the calendar to be displayed therein, an area 225 for designating a date, an area 227 for changing the month of the year of the calendar being displayed, and a cursor 209. Moreover, the broken line in the diagram has been provided for the purpose of description and does not actually exist.

Area 225 for designating a date includes a calendar and indicates whether the sound recording data in which the classification “date” is set in the item of the classification exists or not. The display by inversion takes place if the sound recording data in which the classification “date” is set in the item of the classification and in which a corresponding date is set in the item of the item of the date exists, and if not, the display by inversion does not occur. The dates “5” and “9” in the calendar are displayed by inversion, which indicates that the sound recording data in which the classification “date” is set in the item of the classification are stored for each of the fifth and the ninth of April of the year 2010.

Area 227 includes an area 227A which includes the character string of “PREVIOUS MONTH” and an area 227B which includes the character string of “NEXT MONTH.”

Date specifying portion 64 causes cursor 209 to move within sound recording confirmation screen 220 when the user presses up button 25A, down button 25B, right button 25C, and left button 25D while sound recording confirmation screen 220 is being displayed. If the user presses decide button 13 while cursor 209 is located at the date displayed by inversion within area 225, date specifying portion 64 decides the date at which the cursor is located to be a playback date. Date specifying portion 64 outputs the decided playback date to extracting portion 63A.

To extracting portion 63A, the playback date is inputted from date specifying portion 64. When a date is inputted from date specifying portion 64, extracting portion 63A reads from EEPROM 53 sound recording data 93 in which the same date as the playback date inputted is set in the item of the date. Extracting portion 63A outputs the read sound recording data 93 to sound recording figure display portion 83A and playback portion 62.

To sound recording figure display portion 83A, the position of a time axis within the time frame screen is inputted from time axis display portion 81 and sound recording data is inputted from extracting portion 63A. Sound recording figure display portion 83A displays a sound recording figure on the time axis arranged in time frame screen 210 based on the sound recording data inputted from extracting portion 63A. The sound recording figure, like the reservation figure, is the shape which represents the period between the start time and the finish time of the sound recording data on the time axis. In other words, the sound recording figure is the shape which indicates on the time axis the fact that the sound recording data exists. Here, the sound recording figure used is a rectangular shape. More specifically, sound recording figure display portion 83A specifies the position on the time axis of each of the start time and the finish time being set in the sound recording data and places on the time axis a rectangular sound recording figure whose length in the lateral direction corresponds to the distance between the position of the start time on the time axis and the position of the finish time on the time axis. Sound recording figure display portion 83A outputs the classification included in the sound recording data and the position of the sound recording figure on the time axis as a set to reservation classification symbol placing portion 87.

Since the sound recording figure is displayed on the time axis, the user is able to determine from the figure whether sound recording data of a completed sound recording exists on the time axis or not. In addition, the user is able to recall the sound source of the sound recording data about to be played back, for instance, a program broadcasted by radio and so on, from the start time and the finish time.

Moreover, since the precision of the time axis arranged by time axis display portion 81 is five minutes as described above, when the start time or the finish time is not a multiple of five, the location on the time axis of the rounded time would be specified. More specifically, if the unit of the minutes of the start time is not a multiple of five, the start time is changed to the latest time which is before the start time and whose unit of the minutes is a multiple of five, and the position on the time axis of the start time after the change becomes a start point of the sound recording figure; and if the unit of the minutes of the finish time is not a multiple of five, the finish time is changed to the earliest time which is after the finish time and whose unit of the minutes is a multiple of five, and the position on the time axis of the finish time after the change becomes an end point of the sound recording figure.

To reservation classification symbol placing portion 87, the classification and the position on the time axis of the sound recording figure are inputted as a set from sound recording figure display portion 83A. Reservation classification symbol placing portion 87 places a reservation classification symbol in the vicinity of the sound recording figure. The reservation classification symbol is the symbol which indicates that the sound recording data is the data recorded based on reservation data and which represents the classification of that reservation data, and here, the reservation classification symbol representing the classification “daily” is shown by a double circle, the reservation classification symbol representing the classification “weekly” is shown by a circle, and the reservation classification symbol representing the classification “date” is shown by a triangle.

Since the reservation classification symbol is placed in the vicinity of the sound recording figure, the user is able to recall from the reservation classification symbol the origin of the input of the sound recording data corresponding to the sound recording figure, for instance, a program broadcasted by radio and so on.

The time frame screen displayed on LCD 55 by time frame screen display portion 67 is the same as that shown in FIG. 6.

To playback portion 62, sound recording data is inputted from extracting portion 63A and the display time is inputted from time deciding portion 73. When the user presses decide button 13, playback portion 62 specifies the sound recording data which includes the display time inputted from position deciding portion 79 between a start time and a finish time from among the sound recording data inputted from extracting portion 63A, and plays back the sound data included in the sound recording data.

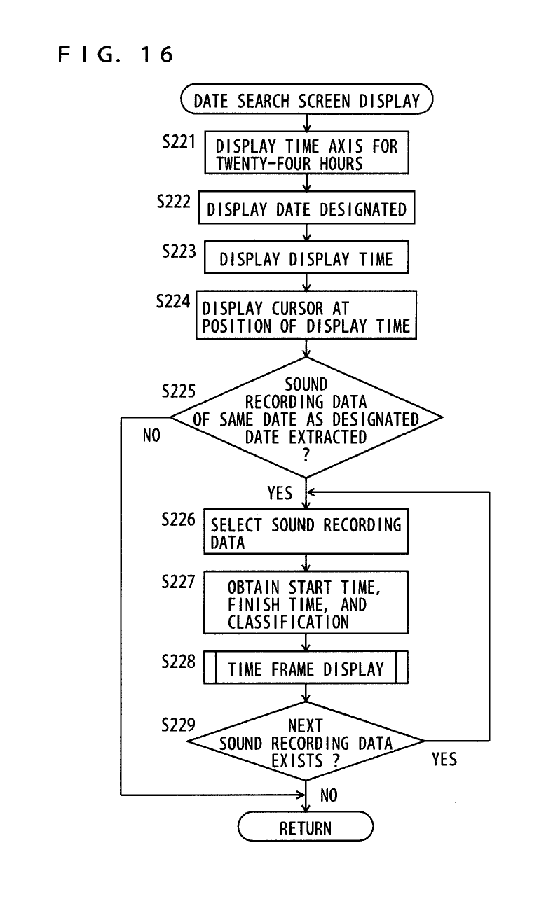

FIG. 15 is a flow chart showing one example of the flow of a date search process. The date search process is the process executed by CPU 11 by executing a playback setting program stored in EEPROM 53. CPU 11 specifies the current date (step S201). In the next step S202, sound recording confirmation screen 220 shown in FIG. 14 is displayed on LCD 55.

In the next step S203, it is determined whether a date has been designated or not. If a date has been designated in sound recording confirmation screen 220 displayed in step S202, the process proceeds to a step S206, but if not, the process proceeds to a step S204. In step S204, it is determined whether an instruction to change the month has been provided or not. If the instruction to change the month has been provided, the process proceeds to a step S205, but if not, the process goes back to step S203. The instruction to change the month is accepted when decide button 13 is pressed while the cursor is located in areas 227A and 227B of sound recording confirmation screen 220. In step S205, the month to be displayed in the calendar is changed, and the process goes back to step S201.

In step S206, it is determined whether playback button 23 has been pressed or not. If playback button 23 has been pressed, the process proceeds to a step S207, but if not, the process proceeds to a step S213. In step S207, it is determined whether or not there is the sound recording data of the same date as the date designated in step S203. If the sound recording data in which the date designated in step S203 is set in the item of the date is stored in EEPROM 53, the process proceeds to a step S208, but if not, the process goes back to step S207.

In step S208, a playback screen is displayed. Then, the sound recording data in which the date designated in step S203 is set in the item of the date is read from EEPROM 53 (step S209), and the sound data is played back (step S210). In a step S211, the process stands by until the playback of the sound data is finished, and when the playback is finished, the process proceeds to a step S212. In step S212, it is determined whether or not there is the sound recording data to be the subject of the playback next. If the sound recording data that has not yet been played exists among the sound recording data in which the date designated in step S203 is set in the item of the date, the process goes back to step S209, but if not, the process is terminated.

On the other hand, in step S213, it is determined whether decide button 13 has been pressed or not. If decide button 13 has been pressed, the process proceeds to a step S214, but if not, the process goes back to step S203. In step S214, the current time is obtained. Thereafter, the obtained current time is set as the display time (step S215). In the next step S216, a date search screen display process is executed, and the process proceeds to a step S217. The details of the date search screen display process will be described later. In the next step S217, a sound recording data decision process is executed. While the details of the sound recording data decision process will be described later, it is the process of obtaining the sound data to be the subject of playback. In a step S218, the playback screen is displayed. Then, the obtained sound data is played back (step S219). In a step S220, the process stands by until the playback of the sound data is finished, and when the playback is finished, the process is terminated.

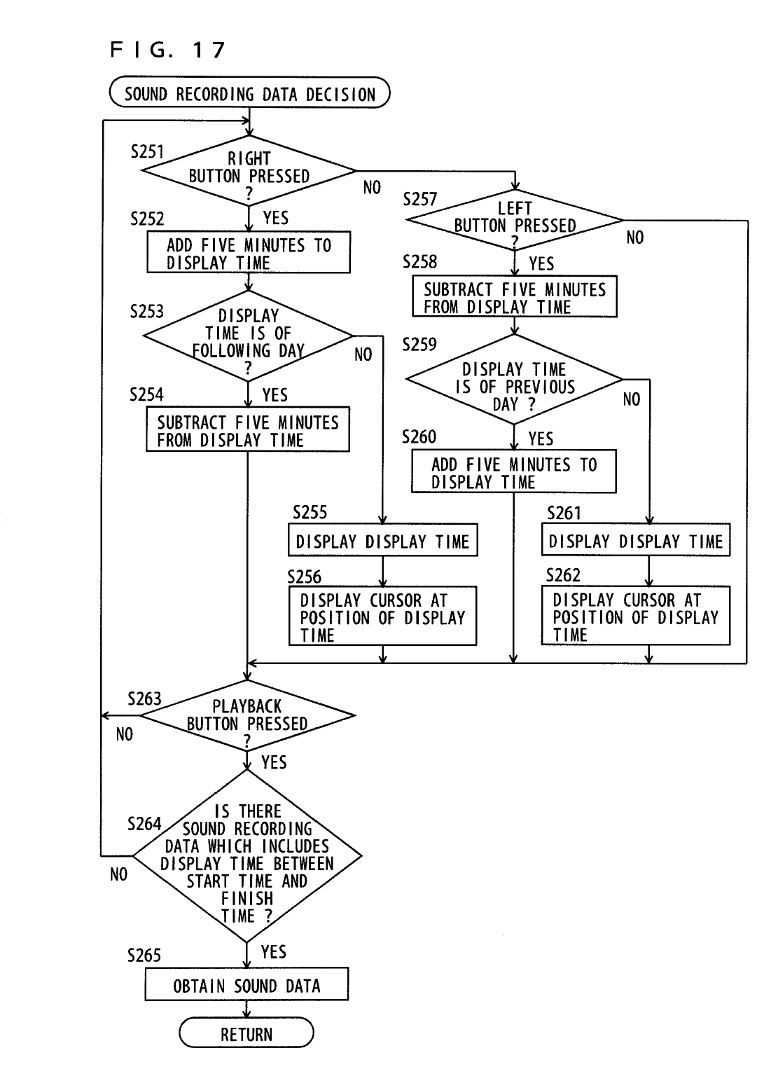

FIG. 16 is a flow chart showing one example of the flow of the date search screen display process. The date search screen display process is the process executed in step S216 shown in FIG. 15. A time axis for one day is displayed (step S221). Here, first time axis 214 and second time axis 215 are displayed. In the next step S222, the date designated in step S203 of FIG. 15 is displayed in area 211. In a step S223, the display time set in step S215 of FIG. 15 is displayed in area 212. In the next step S224, cursor 219 is displayed at the position corresponding to the display time on first time axis 214 and second time axis 215 displayed in step S221.

In the next step S225, the sound recording data of the date that is the same as the designated date is extracted. The sound recording data in which the date designated in step S203 of FIG. 15 is set in the item of the date is extracted from among the sound recording data stored in EEPROM 53. If the sound recording data having the same date as the designated date is extracted, the process proceeds to a step S226, but if not, the process goes back to the date search process.

In step S226, from among the sound recording data extracted in step S225, one is selected. Then, the start time and the finish time being set respectively in the item of the start time and in the item of the finish time of the sound recording data are obtained (step S227). Thereafter, the time frame display process is executed (step S228). The time frame display process shown in FIG. 9 is executed. In the next step S229, it is determined whether or not the sound recording data which has not yet been selected in step S226 exists among the sound recording data extracted in step S225. If the sound recording data which has not yet been selected exists, the process goes back to step S226, but if it does not exist, the process goes back to the date search process.

FIG. 17 is a flow chart showing one example of the flow of the sound recording data decision process. The sound recording data decision process is the process executed in step S217 of FIG. 15. The process in step S251 through step S262 is the same as the process in step S61 through step S72 of FIG. 10, respectively. Thus, the description will not be repeated here.

In a step S263, it is determined whether playback button 23 has been pressed or not. If playback button 23 has been pressed, the process proceeds to a step S264, but if not, the process goes back to step S251. In step S264, it is determined whether or not there is the sound recording data which includes the display time in the period between the start time and the finish time. If the sound recording data which includes the display time in the period between the start time and the finish time is stored in EEPROM 53, the process proceeds to a step S265, but if not, the process goes back to step S251. In step S265, the sound data is obtained from the sound recording data which includes the display time in the period between the start time and the finish time, and the process goes back to the date search process.

IC recorder 1 according to the present embodiment displays a time axis for one day of the date designated by the user in reserved day information setting screen 200, displays on time frame screen 210 in relation to reservation data 91 including the designated date the reservation figures 216 to 218 which indicate that reservations have already been scheduled between the positions on the time axis corresponding to the start times and the positions on the time axis corresponding to the finish times of reservation data 91, and, when any given position on the time axis is designated, generates the reservation data in which the time determined based on the position on the time axis designated is set as the start time or the finish time. Consequently, the user may decide the start time or the finish time of a sound recording while checking the already reserved time frames on the time axis. Thus, the operation of deciding the start time or the finish time of a sound recording is facilitated.

Moreover, although the present embodiment described above is described with regard to IC recorder 1, it goes without saying that the present invention can be construed as a reservation method to cause IC recorder 1 to execute the processes shown in FIG. 7 to FIG. 11 and a reservation program to cause CPU 11 which controls IC recorder 1 to execute the reservation method, and as a playback data search method to cause IC recorder 1 to execute the processes shown in FIGS. 15 to 17 and a playback data search program to cause CPU 11 which controls IC recorder 1 to execute the playback data search method. In addition, in place of IC recorder 1, an electronic equipment such as a digital camera and a mobile phone may be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic equipment, comprising:
a sound recording portion to store sound inputted from outside;
a control portion to cause said sound recording portion to perform a sound recording based on reservation data including at least a start date and time and a finish date and time;
a time display portion to display a time axis for one day of a day;
an extracting portion to extract reservation data whose start date and time or finish date and time is included in the day;
a reservation figure display portion to display, for each of said reservation data extracted, a figure indicating an already scheduled reservation between a starting position on a time axis corresponding to the start date and time and a finish position on a time axis corresponding to the finish date and time of the reservation data;
a designating portion to designate any given position on said time axis displayed; and
a generating portion to generate reservation data in which time determined based on the position designated on said time axis is set as a start time or a finish time.

2. The electronic equipment according to claim 1, wherein said designating portion includes
a cursor display portion to display a cursor that indicates any given position on said time axis, and
a cursor moving portion to move said cursor on said time axis.

3. The electronic equipment according to claim 2, further comprising
an accepting portion to accept at least two operations of a forward operation and a backward operation, wherein
said designating portion includes a deciding portion to decide a position on a time axis of said cursor based on the forward operation or the backward operation accepted by said accepting portion.

4. The electronic equipment according to claim 1, wherein, when said cursor moves only by a minimal distance on said time axis, there is a time difference of at least two minutes before and after a move, said electronic equipment further comprising
an adjustment portion to fine-adjust a time corresponding to a position designated on said time axis at which said cursor is displayed, and wherein
said generating portion sets the time which has been fine-adjusted by said adjustment portion to be a start time or a finish time.

5. The electronic equipment according to claim 1, wherein said reservation data further includes, in order to specify a date to make a sound recording, one designating method selected from three designating methods which are a designating method to specify a date, a designating method to specify a day of the week, and a designating method to specify everyday, said electronic equipment further comprising
a placing portion to place a symbol corresponding to the designating method included in said reservation data in a vicinity of said figure displayed.

6. An electronic equipment, comprising:
a sound recording portion to store sound inputted from outside; and
a control portion to cause said sound recording portion to perform a sound recording based on reservation data including at least a start date and time, a finish date and time, and a designating method for specifying a date to make the sound recording, wherein
the designating method included in said reservation data is one selected from three designating methods which are a designating method to specify a date, a designating method to specify a day of the week, and a designating method to specify everyday; said electronic equipment further comprising:
a time display portion to display a time axis for one day of a day;
an extracting portion to extract reservation data whose start date and time or finish date and time is included in the day;
a reservation display portion to display for each of said reservation data extracted a reservation figure indicating an already scheduled reservation between a starting position on the time axis corresponding to the start date and time and a finish position on the time axis corresponding to the finish date and time of the reservation data; and
a placing portion to place a symbol corresponding to a classification of said reservation data in a vicinity of said reservation figure.

7. An electronic equipment, comprising:
a playback portion to playback sound stored along with sound recording information including at least a start date and time and a finish date and time of a sound recording made;
a time display portion to display a time axis for one day of a day;
an extracting portion to extract sound recording information whose start date and time or finish date and time is included in the day;
a recording display portion to display for each of said sound recording information extracted a sound recording figure indicating a completed sound recording between a starting position on the time axis corresponding to the start date and time and a finish position on the time axis corresponding to the finish date and time of the sound recording information; and
a designating portion to designate any given position on said time axis displayed, wherein said playback portion plays back the sound stored along with the sound recording information corresponding to the sound recording figure when said sound recording figure is displayed at the position designated on said time axis.

8. The electronic equipment according to claim 7, wherein said sound recording information includes a reserved sound recording classification, and
from among a first reserved sound recording classification indicating that a sound recording was made based on reservation data in which a designating method to specify a date is set, a second reserved sound recording classification indicating that the sound recording was made based on reservation data in which a designating method to specify a day of the week is set, and a third reserved sound recording classification indicating that the sound recording was made based on reservation data in which a designating method to specify everyday is set, one is set as said reserved sound recording classification, said electronic equipment further comprising
a placing portion to place a reservation symbol corresponding to the reserved sound recording classification included in said sound recording information in a vicinity of said sound recording figure.

9. A reservation method to cause an electronic equipment to execute the steps of;
recording sound inputted from outside based on reservation data including at least a start date and time and a finish date and time;
displaying a time axis for one day of a day;
extracting reservation data whose start date and time or finish date and time is included in the day;
displaying for each of said reservation data extracted a figure indicating an already scheduled reservation between a starting position on the time axis corresponding to the start date and time and a finish position on the time axis corresponding to the finish date and time of the reservation data;
designating any given position on said time axis displayed; and
generating reservation data in which time determined based on the position designated on said time axis is set as a start time or a finish time.

10. The reservation method according to claim 9, wherein said step of designating the position includes the steps of
displaying a cursor that indicates any given position on said time axis, and
moving said cursor on said time axis.

11. The reservation method according to claim 10, wherein said electronic equipment includes an accepting portion to accept at least two operations of a forward operation and a backward operation, wherein
said designating step includes the step of deciding a position on a time axis of said cursor based on the forward operation or the backward operation accepted by said accepting portion.

12. The reservation method according to claim 10, wherein, when said cursor moves only by a minimal distance on said time axis, there is a time difference of at least two minutes before and after a move, said reservation method further comprising the step of
adjusting a time corresponding to a position designated on said time axis at which said cursor is displayed, and wherein
said step of generating reservation data sets the time which has been fine-adjusted in said adjusting step as a start time or a finish time.

13. The reservation method according to claim 9, wherein said reservation data further includes, in order to specify a date to make a sound recording, one designating method selected from three designating methods which are a designating method to specify a date, a designating method to specify a day of the week, and a designating method to specify everyday, said reservation method further comprising the step of
placing a symbol corresponding to the designating method included in said reservation data in a vicinity of said figure displayed.

14. A reservation method to cause an electronic equipment to execute the step of
recording sound inputted from outside based on reservation data including at least a start date and time, a finish date and time, and a designating method for specifying a date to make the sound recording, wherein
the designating method included in said reservation data is one selected from three designating methods which are a designating method to specify a date, a designating method to specify a day of the week, and a designating method to specify everyday, said reservation method further causes the electronic equipment to execute the steps of;
displaying a time axis for one day of a day;
extracting reservation data whose start date and time or finish date and time is included in the day;
displaying for each of said reservation data extracted a figure indicating an already scheduled reservation between a starting position on the time axis corresponding to the start date and time and a finish position on the time axis corresponding to the finish date and time of the reservation data; and
placing a symbol corresponding to a classification of said reservation data in a vicinity of said figure.

15. A playback data search method to cause an electronic equipment to execute the steps of;
playing back sound stored along with sound recording information including at least a start date and time and a finish date and time of a sound recording made;
displaying a time axis for one day of a day;
extracting sound recording information whose start date and time or finish date and time is included in the day;
displaying for each of said sound recording information extracted a figure indicating a completed sound recording between a starting position on the time axis corresponding to the start date and time and a finish position on the time axis corresponding to the finish date and time of the sound recording information; and
designating any given position on said time axis displayed, wherein
said step of playing back includes the step of playing back the sound stored along with the sound recording information corresponding to the figure when said figure is displayed at the position designated on said time axis.
